(19) United States
(12) Patent Application Publication
(10) Pub. No.: US 2013/0013357 A1
(43) Pub. Date: Jan. 10, 2013

(54) Uniformly Managing Resources and Business Operations

(75) Inventors: Rong Liu, Sterling, VA (US); Anil Nigam, Stamford, CT (US); Zhe Shan, State College, PA (US); Frederick Y. Wu, Yorktown Heights, NY (US)

(73) Assignee: International Business Machines Corporation, Armonk, NY (US)

(21) Appl. No.: 13/224,079

(22) Filed: Sep. 1, 2011

Related U.S. Application Data
(60) Provisional application No. 61/504,612, filed on Jul. 5, 2011.

(51) Int. Cl. G06Q 10/06

(52) U.S. Cl. 705/7.12

(57) ABSTRACT

A system for managing resources and business processes includes a plurality of resource objects stored in a resource object database. Each resource object represents a corresponding resource for use by a business process. Each of the plurality of resource objects includes data pertaining to a state of availability of the corresponding resource.

### CROSS-REFERENCE TO RELATED APPLICATIONS

The present application is based on provisional application Ser. No. 61/504,612, filed Jul. 5, 2011, the entire contents of which are herein incorporated by reference.

### BACKGROUND

1. Technical Field

The present disclosure relates to resource management and, more specifically, to a method and system of uniformly managing resources and business operations.

2. Discussion of Related Art

Business process management (BPM) may be understood as the practice of managing and improving the performance of an enterprise or value-chain through continuous monitoring and optimization of business processes in a closed-loop cycle of modeling, execution, and measurement. Business processes are a set of activities that may be executed and, where appropriate, a sequence in which the activities are to be executed, in the furtherance of commercial or industrial ventures. Business processes may also describe conditions for executing the activities and how variables influence the execution of the activities.

### BRIEF SUMMARY

A system for managing resources and business processes includes a plurality of resource objects stored in a resource object database. Each resource object represents a corresponding resource for use by a business process. Each of the plurality of resource objects includes data pertaining to a state of availability of the corresponding resource.

A resource management application executing on a computer system generates or receives a request for a resource and assigning the request to a selected resource object of the plurality of resource objects based on one or more requirements of the request and the state of availability of the selected resource object. A service executing on a computer system changes the data pertaining to the state of availability of the selected resource object when the request is assigned to the selected resource object.

A method for managing business processes includes receiving a request for a resource from a business process manager. A resource object is selected from a plurality of resource objects, each of which represents a corresponding resource and includes data pertaining to a state of availability of the corresponding resource. The received request is assigned to the selected resource object. The data pertaining to a state of availability of the selected resource object is changed from an available state to a busy state. The assignment is sent to the business process manager. An indication that one or more tasks associated with the request have been completed is received from the business process manager. The data pertaining to a state of availability of the selected resource object is changed from the busy state back to the available state.

A method for managing business processes includes receiving a request for a resource of a plurality of resources from a business process manager. The received request is matched with a selected resource object from a plurality of resource objects, each of which represents a corresponding resource of the plurality of resources and includes data pertaining to a state of availability of the corresponding resource. An interaction between a business process and the selected resource object is initiated by initiating a process flow that includes one or more services provided by the selected resource object and that satisfies requirements of both the business process and the selected resource object. Data pertaining to a state of availability of the selected resource object is changed by invoking the services provided by the resource object in the initiated process flow. An indication that one or more tasks associated with the request have been completed is received from the business process manager.

A computer program product for managing business processes includes a computer readable storage medium having computer readable program code embodied therewith. The computer readable program code includes a plurality of resource objects, each of which represents a corresponding resource and includes data pertaining to a state of availability of the corresponding resource. A resource management application generates or receives a request for a resource and matches the request to a selected resource object of the plurality of resource objects based on one or more requirements of the request and the state of availability of the selected resource object. A service changes the data pertaining to the state of availability of the selected resource object when the request is assigned to the selected resource object.

### BRIEF DESCRIPTION OF THE SEVERAL VIEWS OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1(a) is a diagram illustrating a business entity information model for waiters according to exemplary embodiments of the present invention;

FIG. 1(b) is a flow chart illustrating a simplified life-cycle model for the waiter business entity according to exemplary embodiments of the present invention;

FIG. 2(a) is a flow chart illustrating a life-cycle of the Request business entity type according to an exemplary embodiment of the present invention;

FIG. 2(b) is a flow chart illustrating a life-cycle model for an Assignment according to exemplary embodiments of the present invention;

FIG. 3 is a flow chart illustrating a HandleRequest service according to an exemplary embodiment of the present invention;

FIG. 4 is a diagram illustrating resource management architecture according to exemplary embodiments of the present invention; and

FIG. 5 shows an example of a computer system capable of implementing the method and apparatus according to embodiments of the present disclosure.

### DETAILED DESCRIPTION

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to provide approaches for business process management (BPM) that take into consideration utilization states of various individual resources, both capital and human. In the scheme of BPM, resources are the individuals that are responsible for executing activities, the tools and equipment used in the execution of the activities, and the consumables that are utilized in the execution of the activities. Resources may also include intangible assets such as intellectual property, good will, and the like. Each resource may have its own use state that describes the availability and capacity of each resource. Some resources may only be used once. For example, a sheet of printer paper may only be printed to once before it is rendered exhausted. Other resources may only be applied to one endeavor at a time. For example, a chair may only be able to seat a single person at a time. Still other resources may be able to accommodate some number of simultaneous uses. For example, a web server may be able to accommodate a particular number of users at a given time. Some resources may even be simultaneously applied to any number of endeavors. For example, an aspect of proprietary technology or digital media may be used any number of times without restriction.

Exemplary embodiments of the present invention may define and maintain an object representing each resource, with information pertaining to the state of availability of that object incorporated into that object. The object may define parameters of availability for that resource such as whether the resource is durable or consumable, if it is consumable, what the expected life of the resource is, whether the resource can only be used once at a time or if it is capable of simultaneous use, what the restrictions are on simultaneous use, etc. Accordingly, the object representing the state of availability for a particular resource may include any data that may be used to gauge the current and future availability of that particular resource.

The object for the resource may thereby include parameters defining the conditions of use for the resource as well as the current and/or future state of use of the resource. Because this information is incorporated into the object resource, the BPM system need not be assigned responsibility for tracking use states of various resources and accordingly, a BPM system operating under such a structure may have a great and scalable ability to operate in an environment with numerous resources. Additionally, multiple BPM systems may simultaneously operate while sharing, at least in part, access to resources. According to exemplary embodiments of the present invention, the BPM is freed from the obligation to track availability states of resources, and accordingly, a great many more classes of tangible and intangible things may be contemplated as resources by the BPM without excessively burdening the BPM in the process.

For example, in addition to the management of machinery and people as resources, many other items may be considered resources as well. For example, as described above, consumables and intangibles may be considered resources.

As used herein, the state of use of a resource may include the extent to which the resource is currently being used and its availability to be used further. The resources availability to be used further may include its ability to be used at a given moment or the total amount of life left in that resource before it is fully depleted.

Where resources are human, the object may include information pertaining to the availability of that human resource such as duty schedule, along with information pertaining to what sorts of activities that person is qualified to perform and a measure of that person's capacity to simultaneously handle multiple activities.

Accordingly all available and pertinent information pertaining to the capabilities and availability of each resource may be incorporated into an object associated with that resource. It should be understood that in this context an object is a data entity that may be manipulated by an electronic means. Examples of objects include a value, variable, function, or data structure.

Exemplary embodiments of the present invention may provide an approach for modeling resources for efficient use by BPM systems. Exemplary embodiments of the present invention may also provide for BPM systems that may utilize the resources so modeled. Resources may be systematically modeled as full-fledged business entities and may capture resource behavior and the interactions between resources and business processes in addition to resource availability status. The business entity may be understood to be a data entity, for example, as described above, combined with a characterization of resource behavior. Accordingly, resources according to exemplary embodiments of the present invention may include both a data structure for storing availability states as well as a set of rules or descriptions pertaining to the behavior of the associated resource.

A service-oriented resource management architecture may be used to manage resources and support a range of resource allocation patterns and policies. This architecture may be flexibly integrated with BPM applications to enable monitoring resource utilization and optimizing resource allocation.

As business processes describe a set of activities and the execution order of these activities, business processes tend to involve resources whose availability may be subject to various conditions. In fact, availability and performance of resources may be a major factor in the evaluation of business processes. By adopting an expanded view of what may constitute a resource and by providing a data structure in which the expanded set of resources may be effectively managed, exemplary embodiments of the present invention may provide more efficient and effective business process management.

In this context, a resource may include any person or object that has economic value and may be used by business processes. The disclosure herein may use as an example of a business process the business of restaurant catering. This example is selected because it provides a readily understandable backdrop for the methods and systems described herein. However, it is to be understood that the disclosed methods and systems for business process management described herein may be applied to any arbitrary business process in any field of endeavor be it commercial, industrial, governmental, charitable, or otherwise.

In the example of the restaurant catering business process, resources may include human resources such as waiters and chefs; physical resources such as tables, chairs and menus; and also intangible resources like recipes. The performance of the process may be thought of as effective and efficient use of these resources in the furtherance of the business objective, which may be to serve food to customers for profit. Therefore, appropriately modeling these resources may be used for analyzing process performance and enabling process optimization.

Resources may be dynamic in the sense that their availability states may evolve as they are put into use. The term resource behavior may be used herein to refer to the condition of resources to do work, such as capacity, availability and cost profile. Thus, according to exemplary embodiments of the present invention, resources are stateful, and different resources may have different behavior. Resource management solutions described herein may be flexible enough to accommodate arbitrary types of resources which may each be fully supported. Thus, exemplary embodiments of the present invention provide a generic and flexible resource management architecture that can be plugged into BPM solutions. To this end, resources may be viewed as dynamic objects and may be modeled as business entities. These models may capture both the information and behavior of resources.

Moreover, exemplary embodiments of the present invention may include a loosely-coupled resource management architecture based on service-oriented architecture (SOA) to manage resources, allocate resources to meet process needs, orchestrate resource behavior with business processes, and integrate with other analytical services to optimize resource usage. Often, resource management and BPM are considered two isolated domains in the business space. Exemplary embodiments of the present invention contemplate an expanded view of the relationship between processes and resources in which resources are modeled in a manner that resembles the modeling of other objects, such as business entities, that may be involved in the business process. Accordingly, a process activity may be considered an invocation of services offered by resources. As detailed below, this approach may be highly accurate and may shed light on the interplay between resources and processes.

Exemplary embodiments of the present invention may take into account resource behavior, which can affect the service availability and constrain process execution. Additionally, resource requirements from business processes may determine what resource behavior is of interest. For example, if work is done by resources internal to a business, the business may pay particular attention to the resource schedule and availability. However, if work is contracted for, then resource qualification and performance monitoring may be of primary concern to the business. Business entities may be capable of capturing those different aspects of resource behavior.

Accordingly, exemplary embodiments of the present invention may model stateful resources systematically using the business entity-centric approach. A loosely-coupled resource management architecture based on SOA principles may be used to integrate the stateful resources with BPM applications. This architecture may be used to manage a variety of resources as business entities and support a range of resource allocation policies with the support of external optimization or analytical services. By modeling resource behavior and integrating resource management with BPM, process performance may be closely monitored and business processes may be optimized under resource constraints. Through a holistic view of resources and business processes, the interactions between processes and resources may be illustrated and it may be shown that varying these interactions can lead to different business operation models.

### Modeling Resources and Business Processes

According to a business entity (or business artifact) approach, business entities, which a business strives to produce and manage, consist of two main components—an information model and a life-cycle model. The information model brings together the data elements that the business considers vital to the definition (and hence the production) of the business entity type. The life-cycle model captures the progress (or maturation) of a business entity instance (or business entity or entity, for brevity) from creation to completion (and archival). A business entity is self-contained in the sense that (1) each state (or milestone) along this journey is defined by the amount of information contained in the business entity, and (2) progress from one state to the next requires the specification of the activities that need to be performed to accomplish the transition.

An example of this approach may be described with reference to an Internet-based order for goods. The order instance may be created with a unique identifier or ID and identification of the customer where such information is available. Next, line items may be added to the created order. For example, line items may be picked from a catalogue of items available for purchase. Once the customer has made up her mind as to what items to purchase, payment information may be added to the order. Shipment details are then added and the order is accordingly placed. Further states in the life-cycle of an order might be “awaiting fulfillment,” “ready to ship,” “shipped” etc. The attainment of each state (or milestone) is tantamount to the addition of pertinent information. For example, a “shipped” state might add the date shipped and a tracking number. Generally, a business process involves multiple business entities. Process entities may be used to denote business entities that capture business processes. A business process may be defined as passing through 1 to 10 distinct business entities, as opposed to hundreds of fine-grain data objects. By limiting the number of distinct business entities, the characteristics of the business process may be more easily appreciated by those people having an interest in the business process.

The dependencies between the business entities may involve careful coordination between their respective lifecycles. There may be three basic kinds of dependencies: (1) Creation—as business entity “A” goes from state S1 to state S2, an instance of another business entity “B” may be created. (2) Coordination—specific transitions in two (or more) business entities may be effected simultaneously. (3) Usage—in transitioning business entity “A” from state S1 to state S2, information is used from some other business entity “B” in state S3.

The notion of resources may be introduced into a business process in one of two ways. First, resources may be tied into the transition of a process entity from one state to the next. Accordingly, a transition may require some number of units of a resource, with the resource itself being stateless. According to a second, more flexible and more expressive approach, a resource is modeled as a business entity with the desired life-cycle. As the model of a resource evolves, its life-cycle might become more elaborate. Such a business entity may be called a resource entity. The connection between the process entities and resource entities may be established using the life-cycle dependencies discussed above.

### Resource Management Architecture

Resource management architecture according to exemplary embodiments of the present invention contains resources, resource managers, and other components to support resource allocation. To support extensibility, each component may be designed using SOA principles. These components may interact with each other through service invocations.

According to exemplary embodiments of the present invention, each resource may be modeled as a business entity, for example, a resource entity. The information model of a resource entity describes resource characteristics such as capacity, availability, cost profile, and other data relevant to the use of resources. Resource behavior may change along with resource condition. For example, in the case of a rechargeable battery, the charge capacity and effectiveness of a fully charged battery may be different from that of a partly charged or discharged battery. Resource conditions that affect resource behavior may be captured in a resource entity's life-cycle model, which may be represented as a finite state machine. Where a resource has static behavior, its lifecycle model may be thought of as degenerate. Hence, business entity-centric modeling may be appropriate for both stateful and stateless resources.

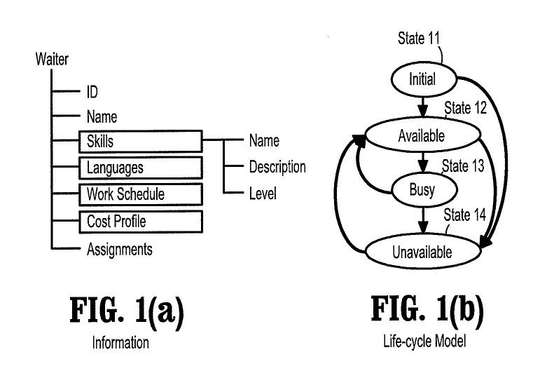

Consider a restaurant business as an example. Examples of people and things that may be considered as resources according to exemplary embodiments of the present invention may include waiters, chefs, tables, cookware, raw food materials etc. FIG. 1(a) is a diagram illustrating a business entity information model for waiters according to exemplary embodiments of the present invention. The information model of FIG. 1(a) includes information regarding skills, languages, work schedule, cost profile, and guests being served, which may be captured as “Assignments.”

FIG. 1(b) is a flow chart illustrating a simplified life-cycle model for the waiter business entity according to exemplary embodiments of the present invention. When a waiter enters the workforce, a new entity may be initialized and its life-cycle may be placed in an “Initial” state (State 11). Depending on whether the waiter can be assigned to work immediately, the life-cycle transitions to either an “Available” state (State 12) or an “Unavailable” state (State 14). In the “Available” state, a waiter may be able to serve one or more additional guests. When the number of guests being served reaches a predetermined limit, the waiter's state may be marked to “Busy” (State 13) to indicate a full workload. A waiter's state may be changed from “Available” (State 12) or “Busy” (State 13) to “Unavailable” (State 14) when exceptions (e.g. taking leave) happen. In this situation, the waiter's active assignments may be delegated to other waiters. Accordingly, the state of a resource may be determined from data stored within an information model that is associated with the particular waiter. For example, information model may store a value indicating a maximum number of guests that can be served by that waiter at a time or this maximum guest value may be calculated from other information stored within the information model. For example, the skill level of a waiter determines how many guests she can serve in parallel. By knowing the number of guests she is currently serving and her skill level, a rule may be used to determine whether the waiter is in an “Available” or “Busy” state.

A state transition in the life-cycle may be implemented as a human activity, a service call, and/or a rule. The state transition may update relevant data in the information model and changes the state when executed. As a self-contained business entity, a resource entity may be packaged as an independent service component with a service interface. Services may be associated with resource entity states or state transitions. When invoked, these services may initiate CRUD (Create, Read, Update, Delete) data operations on resource entity information and/or change entity state. For example, as shown in FIG. 1(b), when a waiter resource entity is in an “Available” state, an “AssignTask” service may be made available. This service may update Assignments in the information model and may also trigger the rule that changes the entity to a “Busy” state.

Other services that may be used may include a “CreateResource” service for generating a new resource, an “UpdateResource” service for updating a state of a resource to a most appropriate state, a “CheckAvailability” service for determining the availability of a resource to determine whether a resource has available capacity to receive an additional assignment, an “AssignTask” service for assigning a new task to a resource, and a “CompleteTask” service for removing a task assignment from a resource.

Other services may also be made available and these services are offered as an example of possible services that may be called upon. These services may be embodied as web services that are hosted on a network such as a local area network (LAN) or a wide area network (WAN) such as the Internet.

Assignments in the Waiter information model shown in FIG. 1(b) may record work assigned to the resource entity. According to exemplary embodiments of the present invention, this information may be modeled as a separate business entity type, which may be called “Assignment.” A resource entity may keep reference to Assignment entities in its information model. The resource entity may access assignment details through the service interface of Assignment business entity type. This separation may simplify the design of resource entities. As described below, the Assignment business entity type may be designed to support different resource allocation scenarios and/or resource patterns.

Resource entities may accordingly be embodied as executable service components. These components may be defined in one of two ways. First, generic business entity models may be developed for some common types of resources such as human resources and physical resources. These models may be used as templates and may be customized for specific resources used in a process. Second, as part of defining a business process, the required resources may be modeled as business entities. The resource entity models may then be imported into a resource management architecture.

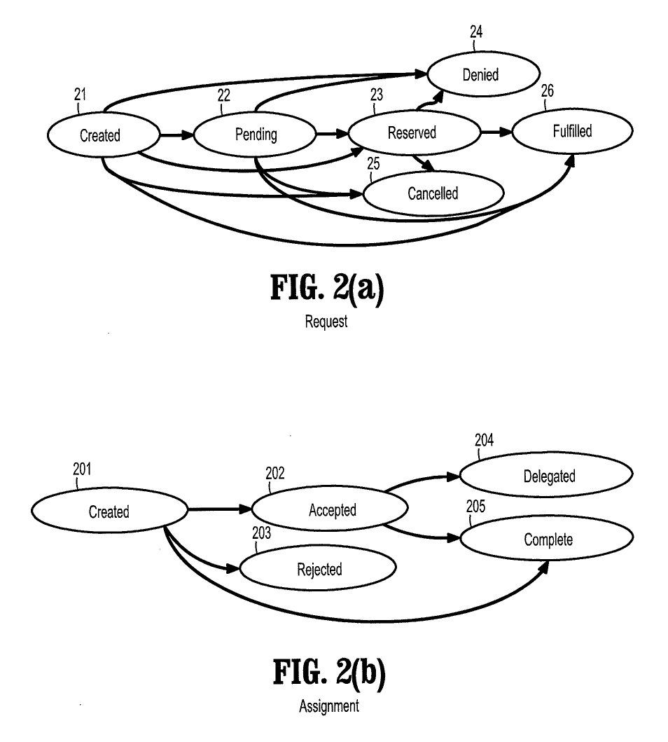

When a resource is needed during process execution, a request may be created. This request may be fulfilled, queued or denied. The request may be modeled as a business entity. FIG. 2(a) is a flow chart illustrating a life-cycle of the Request business entity type according to an exemplary embodiment of the present invention. A request may be created. Upon creation, the request may have a “Created” state (State 21). A Request business entity may be in a “Pending” state (State 22) if resources are temporarily unavailable. The request may be placed in a “Fulfilled” state (State 26) after the request has been successfully completed, a “Denied” state (State 24) after the request has been rejected, or a “Cancelled” state (State 25) if the request is otherwise unsuccessfully ended. A request can be placed in a “Reserved” state (State 23) to indicate that a new Request business entity has been created and reserved for future use.

Various services may be called upon to affect the states of the Request. For example, there may be a “CreateRequest” service for generating a new request, an “UpdateRequest” service for updating a request, a “SearchRequest” service for searching for a request, a “ReserveResource” service for placing the Request in a reserved state, a “PendRequest” for placing the Request in a pending state, a “FulfillRequest” for placing the Request in a fulfilled state, and a “DenyRequest” service for placing a Request in a denied state.

Where a resource is actually assigned at reservation time, an Assignment business entity may be created. The information model of Request may include information about the requester and requested resources including name, quantity, estimated time, and qualifications etc. Request as a business entity may also be packaged as a service component with a service interface.

After a Request entity is created, resources may be assigned to meet the requirements specified in the Request entity. This assignment may be recorded in an Assignment business entity. One or more Assignment business entity instances may be created for a Request, since it may require multiple resources. The information model for an Assignment may contain a reference to a Request business entity, a reference to the assigned resource entity, and the actual usage time of the assigned resource. FIG. 2(b) is a flow chart illustrating a life-cycle model for an Assignment according to exemplary embodiments of the present invention. A newly created Assignment may be in a “Created” state (State 201). After an Assignment entity is created, the assigned resource entity may accept the assignment. An accepted Assignment may be placed in an “Accepted” state (State 202). However, the assigned resource entity may also reject the assignment in exceptional situations. A rejected Assignment may be placed in a “Rejected” state (State 203). When a resource successfully completes the assigned job, the Assignment may have a “Complete” state (State 205). If the resource is reusable, the resource may be returned to an available state after the completion of the Assignment. An accepted assignment may be delegated to other resource entities if the assigned resource entity is unable to successfully complete the Request. In such a case, the Assignment may be placed to a “Delegated” state (State 204).

The Assignment entity may also have a set of associated services. For example, there may be a “CreateAssignment” service for generating a new Assignment, an “UpdateAssignment” service for updating an Assignment, an “AcceptAssignment” service for changing an Assignment to an accepted state, a “CompleteAssignment” service for changing an Assignment to a complete state, a “DelegateAssignment” service for changing an Assignment to a Delegated state, and a, “RejectAssignment” service for changing an Assignment to a rejected state.

Each of the above-named services may be embodied as either a single service or as a flow of multiple sub-services. For example, DelegateAssignment may be composed of two services in sequence: CreateRequest from Request to create a new Request instance and UpdateAssignment from Assignment to change the Assignment entity state to “Delegated” and to add information regarding delegation. These business entity-centric models for Request and Assignment are just illustrative. More sophisticated models may be used where needed. For example, here it may be assumed that a Request entity cannot be partially fulfilled. If partial fulfillment is allowed, the life-cycle model illustrated in FIG. 2(a) may be modified to reflect this scenario. By modeling requests and assignments as business entities, detailed information about each instance as well as its state transitions may be captured. This information may be useful for analysis, auditing and optimization of resource allocation.

Each resource may have its own defined behavior and conditions. One or more resource managers may be responsible for initializing an interaction between BPM applications and resource entities. Resource managers may also be used to allocate resources to BPM applications. Also, a resource manager may implement resource allocation policies to achieve particular business goals. A resource allocation policy, denoted as Pᵣ/Pₐ, describes rules or algorithms used in choosing a request from a queue of Request business entities (Pᵣ) and in selecting resources to match with the request (Pₐ). For example, first-in-first-out (FIFO)/round-robin may denote that a request is chosen in the order in which it was created and a resource is picked from a list of available instances using the “round-robin” policy.

A resource allocation policy may specify a sophisticated process for optimizing resource distribution. For example, processes may be used to forecast seat availability and to assist seat reservation to thereby increase restaurant seating efficiency. However, the resource manager need not implement these processes. Instead, these processes may be implemented outside of resource management as external services. The resource manager may invoke the services during resource allocation. The resource manager may also be implemented as a service component with a service interface. This service interface may contain services to manage resource entity types and assign resource entities to requested BPM applications as follows:

(1) RegisterResource—Register a new resource entity type by deploying its definition to the resource manager. A new entry may be created in the resource entity type table that is maintained by the resource manager.

(2) UnregisterResource—Uninstall a resource entity type from the resource manager.

(3) RegisterBPM—Register a BPM application in the resource manager. The registration may create a BPM application profile along with the application's preferences for resource allocation policies and patterns.

(4) UnregisterBPM—Delete a BPM application's profile from the resource manager.

(5) SearchResource—Search for resource entities by criteria. For example, the resource manager may find waiters who can speak French to serve a guest speaking French. This resource manager may first search its resource entity type table for waiter resource entity type and then searches for instances of the returned entity type whose languages include “French” and whose state is “Available.” Accordingly, this service may include create, remove, update, and delete (CRUD) data services and services provided by resource entities.

(6) SelectResource—This service may select resource entities from a list of available resources based on pre-set resource allocation policies. External analytical or optimization services may be used for this selection.

(7) SelectRequest—this service may first invoke SearchRequest provided by Request business entity to find a list of Request entities by criteria and then it may select one or more Request entities based on pre-set resource allocation policies.

(8) HandleRequest—this service may be trigged when a resource request is received from a BPM application. The service may create a Request entity, find available resource entities that match with the request, and select resource entities based on the application's resource allocation policy. If the selected resource(s) accepts this request, a new Assignment entity may be created and the Request entity may be completed. If no resource is available, the Request entity may be put into a queue (if the request call is asynchronous) or denied (if the request is synchronous).

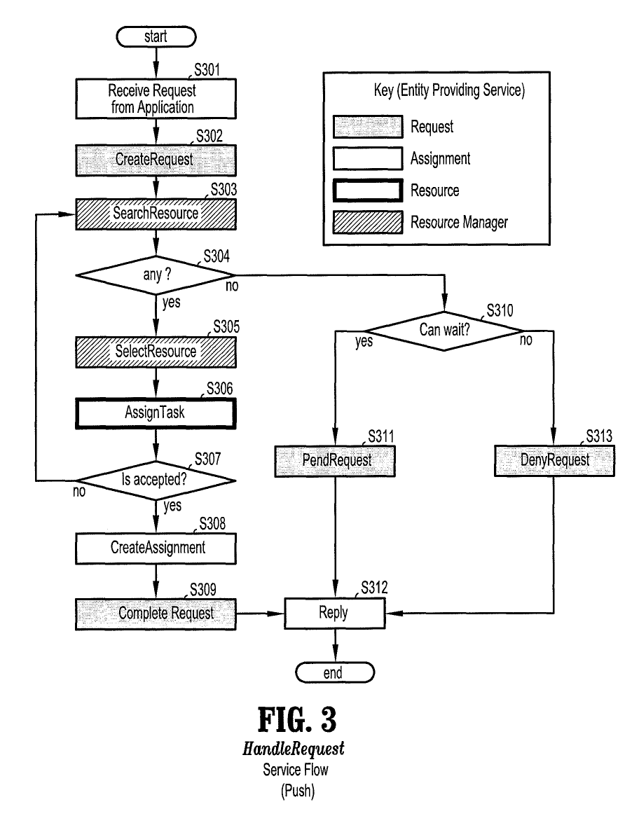

FIG. 3 is a flow chart illustrating a HandleRequest service according to an exemplary embodiment of the present invention. First, a Request may be received from an Application (Step S301). This service may be provided by an Assignment entity.

Next, a new Request may be created, for example, by calling upon a CreateRequest service (Step S302). This service may be provided by a Request entity. Then, a resource may be located, for example, by calling upon a SearchResource service (Step S303). This service may be provided by a resource manager entity. If a resource can be found (Yes, Step S304), then the found resource may be selected, for example, by calling upon a SelectResource Service (Step S305). This service may also be provided by the resource manager entity. Then, a task may be assigned to the selected resource, for example, by calling upon an AssignTask service (Step S306). This service may be provided by a Recourse entity. From there, if the task is accepted by the selected resource (Yes, Step S307) then a new assignment may be created, for example, by calling upon a CreateAssignment service (Step S308). When the task has been completed by the assigned resource then the Request status may be changed to Complete, for example, by calling upon a CompleteRequest service (Step S309). This service may be provided by the Request entity. Then, a reply may be generated, for example, by calling upon a Reply service (Step S312). This service may be provided by the Assignment entity.

If, however, the task is not accepted by the selected resource (No, Step S307), then a new resource is searched for at step S303 and the process may continue as described above.

If, however, no suitable resource may be identified (No, Step S304), then it is determined whether the request can wait. If the request can wait, then the request is set to a pending state, for example, by calling upon a PendRequest service (Step S311). This service may be provided by the Request entity. After the state of the Request has been set to pending, a suitable reply may be generated at step S312. If however, it is determined that the request cannot wait (No, Step S310), then the state of the Request may be set to denied, for example, by calling upon a DenyRequest service (Step S313). This service may also be provided by the Request entity. After the state of the Request has been set to denied, a suitable reply may be generated at step S312.

(9) HandleRelease—For reusable resources, the resource manager may provide a service for BPM applications to release resources after completing tasks. This service takes Assignment entity instance IDs as an input. This service may further invoke a CompleteAssignment service provided by Assignment and a CompleteTask service provided by the corresponding resource entities.

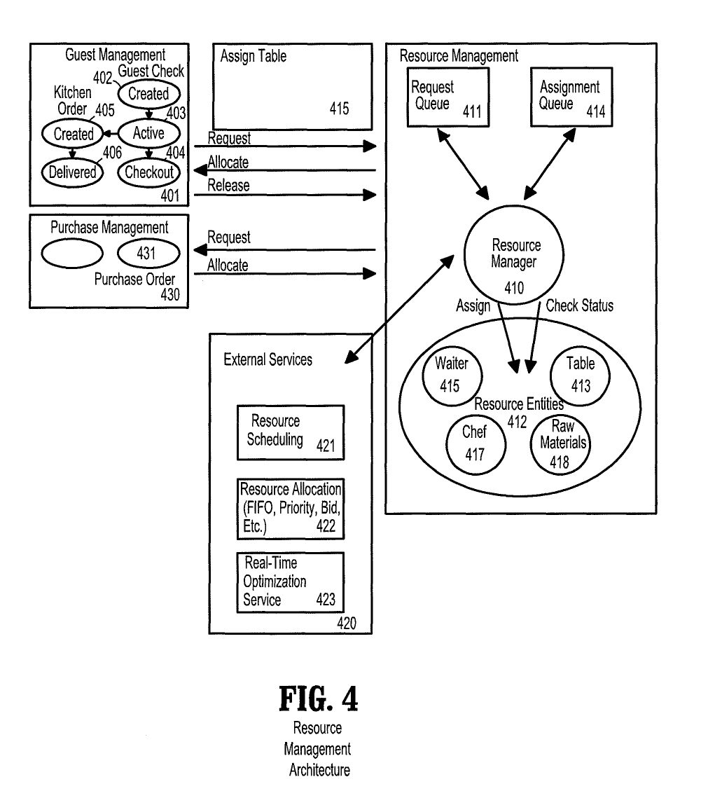

FIG. 4 is a diagram illustrating resource management architecture according to exemplary embodiments of the present invention. In this figure, the restaurant business processes are used as an example of business processes that may be managed according to exemplary embodiments of the present invention, however, it is to be understood that these particular business processes are offered as an example and that the approaches described herein may be applied to all types of business processes. The restaurant business, as described herein, may be contemplated as involving several distinct business processes. Each business process may be managed by a corresponding business process manager. For example, restaurant operation may involve a Guest Management process managed by a guest business process manager and a Purchasing Management process managed by a purchasing business process manager. There may also be additional processes. All processes may be executed in parallel, where desired. Resources in this business may be pooled together and shared by multiple processes. These resources may include inconsumable resources, such as waiters and tables, and consumable food raw materials. Business entities for a consumable resource are stateless and the information model is used for inventory tracking.

To illustrate the integration between processes and resource management architecture in accordance with exemplary embodiments of the present invention, FIG. 4 illustrates how a table is assigned in accordance with the Guest Management process. As shown in FIG. 4, a simplified version of Guest Management process 401 is presented including two process entities: Guest Check and Kitchen Order. When guests arrive, a new Guest Check instance may be generated. The newly created Guest Check instance may be in a “Created” state 402. In this state, a table and a waiter are assigned and this instance transitions to “Active” state 403 in which the guest can order food. Each order creates a new Kitchen Order instance 405. The Kitchen Order instance is completed when the order is delivered 406. The Guest Check and Kitchen Order process entities interact in the Creation pattern. Finally, when the guest checks out 404, the assigned waiter and table are released from the assignment.

The integration between Guest Management Process and Resource Management architecture may be achieved through standard service invocations. For example, to request a table, a HandleRequest service offered by the Resource Manager 410 may be invoked and may send an input message. This input message may specify estimated start and end times of using the table and the number of seats needed (Step 1). These times may be stored in an assignment business entity 415. Upon receiving this input message, the Resource Manager 410 creates a Request entity within a Request Queue 411 by invoking CreateRequest (Step 2). Meanwhile, the Resource Manager 410 may invoke service SearchResource to search the resource entity pool 412 for Table resource entities that are available and have at least five seats. This search may return a list of Table resource entities (Step 3). If no resources are available, this Request instance is put into “Pending” state. When resources are available, the Resource Manager 410 selects a pending Request entity based on the allocation policy 422, for instance, FIFO or priority-based, as stored in the BPM application profile 420. Now the resource manager 410 may choose one table based on the allocation policy specified. In this case, the policy is to minimize average waiting time. To allocate a table, the resource manager 410 may use a process that considers outstanding requests in the request queue 411 as well as availability of tables (Step 4). This process may be considered as a service external to the Resource Management Architecture. The resource manager 411 may utilize a number of external services 420 for scheduling 421 and/or optimization 423. When a table is determined, the resource manager 410 invokes AssignTask service of the Table resource entity 413. This service invocation changes the state of the entity (for instance, to “Occupied” state) (Step 5). Meanwhile, an Assignment business entity instance is created in the assignment queue 414 by invoking CreateAssignment service (Step 6). Here the Table resource entity 413 and the Guest Check process entity interact with each other in a Coordination pattern. Finally, a response is provided to the requester (Step 7). When the guests check out, HandleRelease is invoked so that the actual used time may be recorded in the corresponding Assignment business entity 415 and the state of the used Table resource entity can be updated (Step 8). Information in the Assignment and Request business entities may be useful for calculating key performance measures, such as Revenue per Available Seating Hour, and monitoring restaurant performance in real time. In this illustrative example, resource management is integrated with the business process through service invocation at a process entity state. It is also possible to have the service invocation happen at state transitions that are often implemented as composite service flows. Moreover, even if a business process is not modeled using the business-entity centric approach, it may still incorporate the resource management architecture described herein. In this case, if a resource is needed for activity execution, a service invocation for assigning this resource may be placed either at the initiation or in the middle of activity execution.

In addition to the guest management process 401, a purchase management process 430 may simultaneously execute. This process may generate purchase orders 431 in response to the consumable resources, e.g. raw material resource entities 418, exhausted as a result of the delivery of kitchen orders 406. The same resource manager 410 may process requests and allocations of the purchase management process 430, as shown, or a different resource manager may be used.

Additionally, in addition to managing table resource entities 413, other resource entities such as waiters 416 and chefs 417 may be managed.

The resource management architecture described above may be implemented using a business entity-centric process modeling application. Within this context, the resource management architecture may be composed of business entities. For example, the Resource Manager, Assignment, Request, and a collection of resource entities may each be embodied within this framework as business entities. The Resource Manager business entity may have simple information and life-cycle models but a rich service interface as described above. The services defined for each business entity may be implemented as flows, for example, lightweight service flows similar to BPEL. These services may be exposed at the application level. Business processes, such as Guest Management, may also be implemented as applications. An application may also be allowed to invoke services provided by other applications or published web services.

Exemplary embodiments of the present invention may accordingly provide for an architecture that is flexible enough to handle any number of resources as resource states are stored locally in resource objects thereby freeing the resource manager from the burden of managing the states for a very large number of resources. Because multiple resource managers may be utilized and may call upon a pool of self-managed resource entities, a resource management system utilizing exemplary embodiments of the present invention may be able to be easily expanded by increasing the number of available resources without risk of overburdening a resource manager.

Accordingly, the exemplary embodiments described herein provide for an architecture that is both pluggable and flexible. As this architecture may incorporate SOA principles, it may be integrated with BPM applications in a plug-and-play manner. If an activity is defined with resource requirements, requesting resources may become a part of the activity execution.

An activity user interface (UI) may be used to help human users and services to invoke the service for requesting resources. Moreover, the same resource management architecture may be shared by multiple business processes. Each business process can define its own resource entity models and import them into the architecture. With this architecture, an enterprise may be able to build a resource management application that manages all enterprise resources and optimizes their usage enterprise-wide. The enterprise may therefore not be limited to staying within a process or a line of business. The types of resources that may be supported by this architecture are not constrained. Instead, each business process may have its own resource definitions as business entities, and this architecture may support rich behavior of resource entities.

Many changes may be made to the above-described exemplary embodiments without materially departing from the scope of the disclosure. For example, the HandleRequest service flow illustrated in FIG. 3 is described as utilizing a Push pattern, where a request is assigned to a resource by the resource manager. Exemplary embodiments of the present invention may also support a Pull pattern, where resource entities actively choose matching requests. For this pattern, a SelectRequest may be utilized. This service may be similar to SelectResource. A resource entity may invoke this service to find matching Request entities and to choose one by the application's resource allocation policy. Then, the resource entity may make an assignment by invoking AssignTask, CreateAssignment, and CompleteRequest, in a manner similar to the push pattern shown in FIG. 3. In addition, FIG. 2 shows that delegation and reservation can be supported through the modeling of Request and Assignment. Other patterns such as Shortest Queue, Random Allocation and Round Robin Allocation, may also be treated as resource allocation policies that are implemented as external services.

The operation of a business may be particularly concerned with managing resources efficiently. Many performance indicators of the business depend on the amount of resources consumed, the time over which the resources are occupied, and the costs of these resources. Based on these measurements, a variety of consumption rates and elapsed times in various parts of the business processes and expenses may be computed. Exemplary embodiments of the present invention may utilize a notion of resource that may be incorporated as a first class entity when characterizing business entities as well as business processes. This modeling paradigm may capture the resource-related metrics commonly required in business performance monitoring. Thus, this unified framework may enable a systematic way to design a business performance monitor model in which resource entities provide supporting information of the key performance indicator (KPI) calculation for business processes and also generate a resource view of real-time business performance. For example, in the restaurant example described above, a determination is made as to how many resources each guest used based on the information in Assignment entity instances, and a determination is made as to how much the used resources cost based on the information in Resource entity instances. Calculated based on this information, the KPIs, for example, average resource cost per guest and average revenue per seat hour, may show how well the business is running.

On the other hand, the usage and allocation of a specific resource entity such as Waiter may be calculated. The restaurant can check the average workload and assignment distribution (e.g. which business process occupies most of this resource) to decide whether it needs to adjust its hiring plan or allocation policies. These two aspects of performance monitoring both depend on the resource information and usage data, which may be fully captured in this approach.

Moreover, exemplary embodiments of the present invention demonstrate a way to model the relationship between business processes and resources. Rather than treating a resource as a simple attribute having a special association with an activity, such as a “role” performing the activity, the resource may be elevated to a full-fledged business entity on an equal basis with process entities. Just as multiple process entities may interact during process execution through service invocations, so are the services provided by resource entities invoked by the process entities during activity execution. This approach to resource modeling allows for the careful modeling of resource behavior using the business entity-centric approach. Business processes may be supported or constrained by resource behavior and allocations. The process performance can be enhanced by changing or adapting to resource behavior. In some cases, a business process may accommodate some particular aspect of resource behavior. An example is that if a resource is rare but indispensable to a process, the process may be orchestrated around resource availability. Additionally, business processes may provide the context that determines what resource information and behavior are of interest, how resources are allocated, and how resources behave. Processes and resources may interact in different patterns, for instance, reservation and delegation etc. These patterns affect how resources are modeled. For example, if delegation is allowed, resource entities may capture the information of delegated resource entities. According to exemplary embodiments of the present invention, the business entity-centric modeling provides the flexibility to support a range of resource patterns. Moreover, processes may request resources to be allocated under a range of policies (e.g. FIFO), which in turn, impact the workload of resource entities and then resource behavior. For instance, resources may be allocated equitably so that resources can behave in a similar fashion. Exemplary embodiments of the present invention may integrate with external services to support different allocation policies. In addition, in some cases, a resource entity may be considered as a continuation of a business entity produced by a process. For example, in a computer server provisioning process, a server may often be modeled as a business entity. The process ends when the server is deployed. At this moment, the server becomes a resource for other processes. Therefore, resources may be modeled as business entities. Here, resource entities and process entities may be distinguishable in the use of a Resource Manager to manage the requests for resources and their assignments to requests.

Exemplary embodiments of the present invention model resources as fullfledged business entities to capture rich behavior of resources that affect business process execution. An SOA-based resource management architecture may be used to manage resource entities and flexibly support a range of resource allocation patterns and policies. This loosely coupled architecture may be integrated into existing BPM applications in a plug-and-play manner. The integration between resource entities and BPM enables monitoring of detailed resource utilization and optimizing resource usage to enhance process performance. This new architecture may also be applied to engagements in a resource intensive domain, such as government or municipal services.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

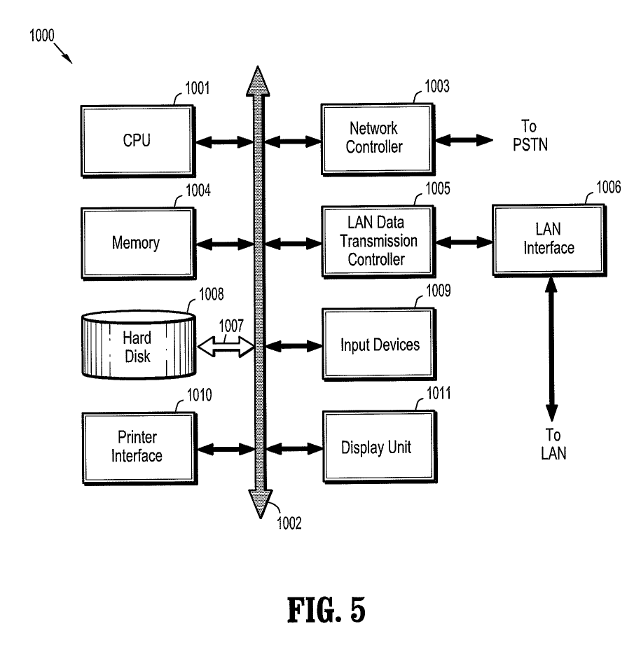

FIG. 5 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A system for managing resources and business processes, comprising:
a plurality of resource objects stored in a resource object database, each of which represents a corresponding resource for use by a business process, each of the plurality of resource objects including data pertaining to a state of availability of the corresponding resource;
a resource management application executing on a computer system, generating or receiving a request for a resource and assigning the request to a selected resource object of the plurality of resource objects based on one or more requirements of the request and the state of availability of the selected resource object; and
a service executing on a computer system, changing the data pertaining to the state of availability of the selected resource object when the request is assigned to the selected resource object.

2. The system of claim 1, wherein the business process includes at least one activity which incorporates one or more service invocations for utilizing one or more resources corresponding to one or more resource objects of the plurality of resource objects.

3. The system of claim 1, wherein the data pertaining to a state of availability of the corresponding resource includes one or more of resource capacity, cost profile, allocation requirements, or other information relevant to resource use.

4. The system of claim 1, wherein the request is additionally assigned to the selected resource object based on allocation requirements of the selected resource.

5. The system of claim 1, wherein an interaction between the business process and the selected resource is initiated by a process flow satisfying requirements of both the business process and the selected resource, the process flow either being predetermined or dynamically composed.

6. The system of claim 1, further comprising one or more additional services that are capable of changing the state of the selected service.

7. The system of claim 1, wherein the state of availability of the selected resource is further changed in response to a request.

8. The system of claim 1, wherein each of the plurality of resources manages changes to its own state of availability through one or more services that are provided by the resource.

9. The system of claim 1, wherein the resource management application selects the resource object that the request is assigned to from the plurality of resource objects stored in the resource object database based on a resource allocation policy.

10. The system of claim 1, wherein each of the plurality of resource objects additionally includes data pertaining to capabilities of the corresponding resource.

11. The system of claim 1, wherein the service changes the data pertaining to the state of availability of the selected resource object from an available state to a busy state when the request is assigned to the selected resource object.

12. The system of claim 1, wherein the service changes the data pertaining to the state of availability of the selected resource object from a busy state to an available state after one or more tasks associated with the request have been completed.

13. The system of claim 1, wherein the resource management application invokes an external service for selecting the resource object of the plurality of resource objects based on one or more requirements of the request and the state of availability of the selected resource object.

14. The system of claim 1, wherein each of the plurality of resource objects is modeled as a business entity.

15. The system of claim 1, additionally including a business processes manager generating the request, sending the request to the resource management application, receiving the assignment from the resource management application, and providing the resource management application with an indication of when one or more tasks associated with the request have been completed.

16. The system of claim 8, wherein the data pertaining to a state of availability of the selected resource is changed again when the resource management application receives the indication of when one or more tasks associated with the request have been completed.

17. A method for managing business processes, comprising:
receiving a request for a resource from a business process manager;
selecting a resource object from a plurality of resource objects, each of which represents a corresponding resource and includes data pertaining to a state of availability of the corresponding resource;
assigning the received request to the selected resource object;
changing the data pertaining to a state of availability of the selected resource object from an available state to a busy state;
sending the assignment to the business process manager;
receiving, from the business process manager, an indication that one or more tasks associated with the request have been completed; and
changing the data pertaining to a state of availability of the selected resource object from the busy state back to the available state.

18. The method of claim 17, wherein the selecting of the resource object from the plurality of resource objects is based on a resource allocation policy.

19. The method of claim 17, wherein the selecting of the resource object from the plurality of resource objects is based on data pertaining to capabilities of the corresponding resource of the selected resource object.

20. The method of claim 17, wherein one or more external services are invoked for selecting the resource object from the plurality of resource objects.

21. The method of claim 17, wherein one or more external services are invoked for changing the data pertaining to a state of availability of the selected resource object.

22. A method for managing business processes, comprising:
receiving a request for a resource of a plurality of resources from a business process manager;
matching the received request with a selected resource object from a plurality of resource objects, each of which represents a corresponding resource of the plurality of resources and includes data pertaining to a state of availability of the corresponding resource;
initiating an interaction between a business process and the selected resource object by initiating a process flow that includes one or more services provided by the selected resource object and that satisfies requirements of both the business process and the selected resource object;
changing data pertaining to a state of availability of the selected resource object by invoking the services provided by the resource object in the initiated process flow; and
receiving, from the business process manager, an indication that one or more tasks associated with the request have been completed.

23. The method of claim 22, wherein the initiated process flow further includes one or more services provided by a resource manager managing the plurality of resources, a request object, an assignment object, or from a resource of the plurality of resources other than the selected resource.

24. A computer program product for managing business processes, the computer program product comprising a computer readable storage medium having computer readable program code embodied therewith, the computer readable program code comprising:
a plurality of resource objects, each of which represents a corresponding resource and includes data pertaining to a state of availability of the corresponding resource;
a resource management application, generating or receiving a request for a resource and matching the request to a selected resource object of the plurality of resource objects based on one or more requirements of the request and the state of availability of the selected resource object; and
a service, changing the data pertaining to the state of availability of the selected resource object when the request is assigned to the selected resource object.

25. The computer program product of claim 24, wherein each of the plurality of resources manages changes to its own state of availability through one or more services that are provided by the resource.

26. The computer program product of claim 24, wherein the resource management application selects the resource object that the request is assigned to from the plurality of resource objects stored in the resource object database based on a resource allocation policy.
